(19) United States
(12) Patent Application Publication
(10) Pub. No.: US 2005/0042581 A1
(43) Pub. Date: Feb. 24, 2005

(54) Communication service system and method based on open application programming interface for disabled persons

(76) Inventors: Hyun Woo Oh, Suwon (KR); Moon Kyun Oh, Daejeon (KR); Young Boo Kim, Gongju (KR); Kwon Chul Park, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/723,026

(22) Filed: Nov. 25, 2003

(30) Foreign Application Priority Data
Aug. 18, 2003 (KR) 2003-0056777

(51) Int. Cl. G09B 21/00

(52) U.S. Cl. 434/112

(57) ABSTRACT

An open API gateway unit provides an open API communication interface for the wired/wireless integrated network. An open API unit grasps communication characteristics of the terminal unit and accommodates a plurality of application functions for the communication services provided to the terminal unit. An open API communication server unit registers the communication characteristics of the terminal unit and provides voice and/or text communication services for the disabled person depending on the registered communication characteristics of the terminal unit. A voice and text conversion unit converts data received from the open API communication server unit into voice and/or text having a format of requested service data depending on the characteristics of the disabled person, and returns the voice and/or text to the open API communication server unit.

### BACKGROUND OF THE INVENTION

1. Field of the Invention

The present invention relates, in general, to a communication service system based on an open application programming interface for disabled persons and, more particularly, to a communication service system and method based on an open application programming interface, which enables a person having a disability in communication means, such as visual, auditory or speech disabilities, to freely and efficiently communicate with other disabled persons and non-disabled persons for the exchange of thoughts or feelings.

2. Description of the Prior Art

Generally, the basic means for exchanging thoughts or feelings between peoples includes hearing, speaking, reading, writing, etc. If a person has a disability in communication means, existing communication media cannot provide the functionality of allowing disabled persons to conveniently use the media.

In the prior art, there are communication services for the exchange of thoughts or feelings, such as a voice service using a telephone as a communication medium, email and instant messaging services using a computer as a medium, a Voice over Internet Protocol (VoIP) service using an Internet phone as a medium, and a letter service using letters as a medium.

In the case of the voice service using the telephone and the Internet phone as a communication medium, a visually disabled person can speak on the telephone or Internet phone to express his or her thoughts or feelings to an opposite party or listen to the opposite party, thus realizing communication there between. However, an auditorily disabled person cannot listen to an opposite party on the telephone or Internet phone. Further, a speech disabled person cannot express his or her thoughts or feelings to an opposite party on the telephone or Internet phone.

In the case of the email and instant messaging services using a computer as a media, auditorily and speech disabled persons can communicate with opposite parties by entering or reading characters. However, a visually disabled person cannot read characters and has difficulty in entering characters, so that the visually disabled person cannot express his or her thoughts or feelings by email and instant messaging services.

The conventional communication services for the exchange of thoughts or feelings are problematic in that, since only non-disabled persons are taken into consideration, it is difficult for disabled persons to easily and conveniently use the services. Further, the conventional communication services are problematic in that, since the characteristics of the disabilities are not taken into consideration, an obstacle to communication between a disabled person and a non-disabled person, as well as communication between disabled persons, is formed, thus creating an estrangement between non-disabled persons and disabled persons, and decreasing the expectation of the disabled persons for the participation in society.

In the meantime, Korean Pat. No. 10-0248391 (Pat. Appl. No. 10-1998-14704) discloses a system comprised of an input/output system and a communication system so as to carry out communication between a visually disabled person and an auditorily disabled person, and a method thereof. In the above patent, the input/output system is implemented using a keyboard for the visually disabled person and Braille, which are communication means of the visually disabled person. The communication system is implemented so that a position and direction sensor worn on an arm necessary for sign language, which is the communication means of the auditorily disabled person, and a joint sensor worn on a hand of the auditorily disabled person are connected to a computer. In the above patent, if the visually disabled person inputs a message to a control unit through an input unit, the control unit converts the message into a sign language motion, and displays the sign language motion as sign language motion images through a sign language motion database (DB). Further, if the auditorily disabled person expresses his or her thoughts or feelings using sign language with the position and direction sensor on his or her arm required to use the sign language and the joint sensor on his or her hand, the control unit receives position information of the hand and the arm and outputs a communication message in Braille. However, the above patent is problematic in that it only provides a system for communication between the visually disabled person and the auditorily disabled person, but it does not take into account communication service characteristics for disabled persons having various characteristics and non-disabled persons.

Further, in connection with a homepage supporting voice for visually disabled persons, there was published a thesis entitled “Design and implementation of homepage supporting voice for visually disabled persons” by H. I. Choi et al., a collection of autumn technical research theses of Korea Information Science Society, Vol. 27, No. 2, pp 275-277, Oct. 2000. In the thesis, a part for converting data into voice and a part for transmitting the voice are added to a typical Web site programming scheme in which, if a client requests data from a Web server through a Web browser, the Web server searches a DB for the data requested by the client using a script or an external program, and transmits the data to the Web browser of the client.

However, in the case of the thesis, there is a problem in that the thesis is published to design a homepage only for visually disabled persons, so that it cannot sufficiently provide a communication service between other disabled persons and non-disabled persons.

### SUMMARY OF THE INVENTION

The present invention provides a communication service system and method based on an open Application Programming Interface (API) for disabled persons, which can provide communication services for enabling a person having a disability in communication means, such as visual, auditory and speech means, to freely and efficiently communicate with other disabled persons and non-disabled persons for the exchange of thoughts or feelings using existing communication media and disabled person-only communication media so as to solve problems generated at the time of communication between disabled persons or between disabled persons and non-disabled persons.

In addition, the present invention provides a communication service system and method based on an open API, which reduces an estrangement between disabled persons and non-disabled persons through the communication there between, improves a understanding of the disabled persons of the non-disabled persons and inspires the confidence of the disabled persons for the participation in society, thus enabling the disabled persons and the non-disabled persons to understand and cooperate with each other.

Furthermore, the present invention provides a communication service system and method based on an open API, which provides a voice/data integrated service applicable to a new generation wired/wireless integrated network in which wired and wireless communications are integrated and broadcasting and communication are merged, thus differentiating and transmitting services depending on the characteristics of communication media.

In order to accomplish the above and other objects, the present invention provides a communication service system based on an open Application Programming Interface (API) for disabled persons, comprising a terminal unit implemented for a disabled person and a non-disabled person that access a wired/wireless integrated network and desire to be provided with communication services depending on communication characteristics registered with respect to the disabled person and the non-disabled person; an open API gateway unit for providing an open API communication interface for the wired/wireless integrated network; an open API unit for grasping communication characteristics of the terminal unit and accommodating a plurality of application functions for the communication services provided to the terminal unit; an open API communication server unit for registering the communication characteristics of the terminal unit and providing voice and/or text communication services for the disabled person depending on the registered communication characteristics of the terminal unit; and a voice and text conversion unit for converting data received from the open API communication server unit into voice and/or text having a format of requested service data depending on the characteristics of the disabled person, and returning the voice and/or text to the open API communication server unit.

Further, the present invention provides a method of providing communication services based on an open Application Programming Interface (API) for disabled persons, comprising the steps of a) registering communication characteristics of terminals of a disabled person and a non-disabled person, desiring to be provided with a corresponding open API communication service in an open API communication server; b) requesting the open API communication server to establish communication with a terminal of an opposite user desiring to use the communication service, using the registered terminal; c) the open API communication server grasping communication characteristics of the terminals of the transmitting user and the opposite user, informing the transmitting user terminal that the communication service is available, and determining whether voice and/or text conversion for the communication service is required when a message is received from the transmitting user terminal; d) converting the message into voice/text data depending on the communication characteristics of the opposite user terminal by a voice and text conversion center and providing the communication service using the voice/text, when the voice and/or text conversion is required; and e) providing the communication service using the message when the voice and/or text conversion is not required.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view showing the construction of a network of a communication service system based on an open API for disabled persons according to the present invention;

FIG. 2 is a block diagram of an open API unit of the open API communication service system for disabled persons according to the present invention;

FIG. 3 is a detailed functional block diagram of the open API communication service system for disabled persons according to the present invention;

FIG. 4 is a flowchart of a method of providing an open API communication service for disabled persons according to an embodiment of the present invention.

### DESCRIPTION OF THE PREFERRED EMBODIMENTS

The present invention provides a communication service system and method based on an open Application Programming Interface (API) for disabled persons. In the present invention, a person having a disability in communication means registers communication characteristics of a subscriber terminal in an open API communication service server using a Personal Computer (PC)-based and voice-based disabled person-only terminal, and calls a desired opposite user. The open API communication service server analyzes previously registered characteristics of a terminal of the opposite user being called, and modifies and transmits a service to correspond to the characteristics of the terminals of the caller and the opposite user. If a visually disabled person communicates with an auditorily disabled person through communication characteristics, such as “hearing” and “speaking”, voice data, obtained when the visually disabled person speaks, are routed to a voice and text conversion center so as to convert the voice data in the format of service data transmitted to the auditorily disabled person by the open API. The voice and text conversion center converts the voice data of the visually disabled person into text and returns the text to the open API. The open API transmits the text data of the visually disabled person to the auditorily disabled person, thus enabling communication between the visually disabled person and the auditorily disabled person to be performed for the exchange of thoughts or feelings.

Hereinafter, a communication service system and method based on an open API for disabled persons according to embodiments of the present invention will be described in detail with reference to the attached drawings.

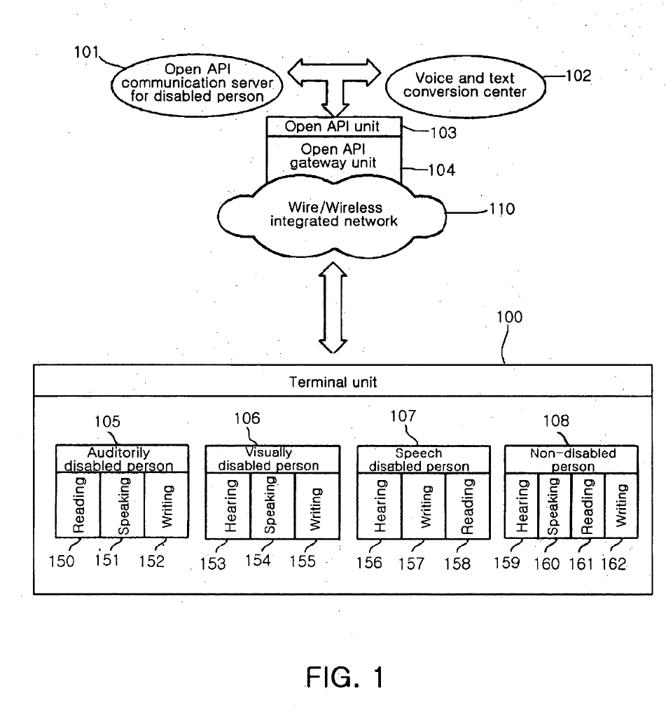

FIG. 1 is a view showing the construction of a network of a communication service system based on an open API for disabled persons according to the present invention. Referring to FIG. 1, the network includes an open API communication server 101 for disabled persons, a voice and text conversion center 102, an open API unit 103 provided to applications, an open API gateway unit 104 for providing a network interface, a wired/wireless integrated network 110, and a user terminal unit 100 sorted depending on the characteristics of used communication.

The user terminal unit 100 has communication characteristics for communication services, and includes terminals 105, 106, 107 and 108, which can be used by an auditorily disabled person, a visually disabled person, a speech disabled person and a non-disabled person, respectively. Further, the user terminal unit 100 has communication characteristics 150 to 162 supported depending on the user terminals 105 to 108. Preferably, the users transmit their desired thoughts or feelings through a user interface U1 for hearing, speaking, reading, writing, etc. The user terminals 105 to 108 support communication characteristics which can be used by the non-disabled person, the auditorily disabled person, the visually disabled person, and speech disabled person. Each user desiring to be provided with a communication service using the disabled person-only terminals 105 to 107 and the non-disabled person's terminal 108 first registers the communication characteristics 150 to 162 of the user terminal in the open API communication server 101 for disabled persons. After the registration, the user desiring to use a communication service with an arbitrary opposite user requests the open API communication server 101 to access the communication service through an interface having available communication characteristics.

The open API gateway unit 104 supports protocols, such as Session Initiation Protocol (SIP), Media Gateway Control (MAGACO) protocol, H. 323 protocol, Integrated Services Digital Network (ISDN) User Part (ISUP), Mobile Application Protocol (MAP), Intelligent Network Application Protocol (INAP) and Capabilities Application Protocol (CAP), which are used in the wired/wireless integrated network. Further, the open API gateway unit 104 exploits middleware, such as Common Object Request Broker Architecture (CORBA) and Extensible Markup Language (XML), so as to communicate with the open API communication server 101.

The wired/wireless integrated network 110 includes a wireless telephone network, a wired telephone network, a VoIP network, and a public IP network, which are connected to the user terminals 105 to 108 having different communication characteristics 150 to 162. If the communication means for the exchange of thoughts or feelings between peoples are classified into “hearing”, “speaking”, “reading” and “writing”, the non-disabled person can use the terminal 108 having the communication characteristics of “hearing” 159, “speaking” 160, “reading” 161, and “writing” 162 that are used as an interface. The visually disabled person can use the terminal 106 having the communication characteristics of “hearing” 153, “speaking” 154 and “writing” 155 that are used as an interface.

The open API communication server 101 for disabled persons registers the communication characteristics 150 to 162 of the user terminals 105 to 108 of the non-disabled person and disabled persons, desiring to use the communication service for the exchange of thoughts or feelings. The open API communication server 101 registers the communication characteristics of the users and the user terminals. Further, if a connection request to use the communication service is received from an arbitrary user terminal, the open API communication server 101 provides voice and text services in consideration of the communication characteristics of transmitting and receiving user terminals. If conversion into voice and/or text is required to support the requested communication service, the open API communication server 101 routes communication service data requiring the conversion to the voice and text conversion center 102.

The voice and text conversion center 102 converts text data and voice data received from the open API communication server 101 for disabled persons in the format of requested service data, and returns the converted service data to the open API communication server 101.

The open API communication server 101 receives the converted service data from the voice and text conversion center 102, and then provides the communication service requested by the user terminal with the communication characteristics of the transmitting and receiving user terminals taken into consideration.

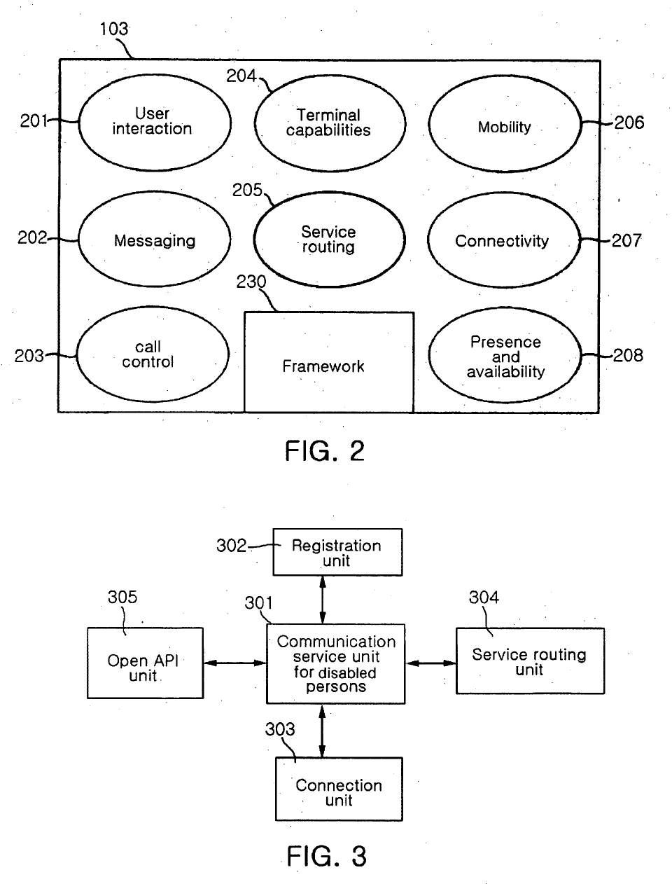

FIG. 2 is a block diagram of the open API unit of the open API communication service system for disabled persons according to the present invention. The open API unit 103 includes a framework 230 and service capability features 201 to 208. To guarantee the stabilization and management of the network, the framework 230 provides the functions, such as management for reliability and security, service discovery, service access, service registration, event advertisement, integrity management, load management and fault management. The service capability features 201 to 208 provide the functions, such as user interaction 201, messaging 202, call control 203, terminal capabilities 204, service routing 205, mobility 206, connectivity 207, and presence and availability 208 so as to allow application services to access and use the resources and functions of the network. Especially, the service routing function 205 allows the open API unit 103 to grasp the communication characteristics of the terminals using the terminal capability function 204 and provides the service routing function for voice and text conversion in consideration of the characteristics of transmitting and receiving user terminals when an arbitrary user attempts a request for a communication service with an arbitrary opposite user.

FIG. 3 is a detailed functional block diagram of the open API communication service system for disabled persons according to the present invention. Referring to FIG. 3, the open API communication service system for disabled persons includes a communication service unit 301 for disabled persons, a registration unit 302, a connection unit 303, a service routing unit 304, and an open API unit 305. The communication service unit 301 provides a communication service in which communication characteristics between disabled persons and between a non-disabled person and a disabled person are taken into consideration. The registration unit 302 registers the characteristics of the terminals when the terminals use the communication service first time. The connection unit 303 sets up a call in response to a communication service request received from the user while supporting the network interface. The service routing unit 304 routes a service to support the conversion into voice and text in consideration of the characteristics of the respective terminals at the time of providing the communication service. The open API unit 305 provides API to allow a higher application to securely and easily use network resources.

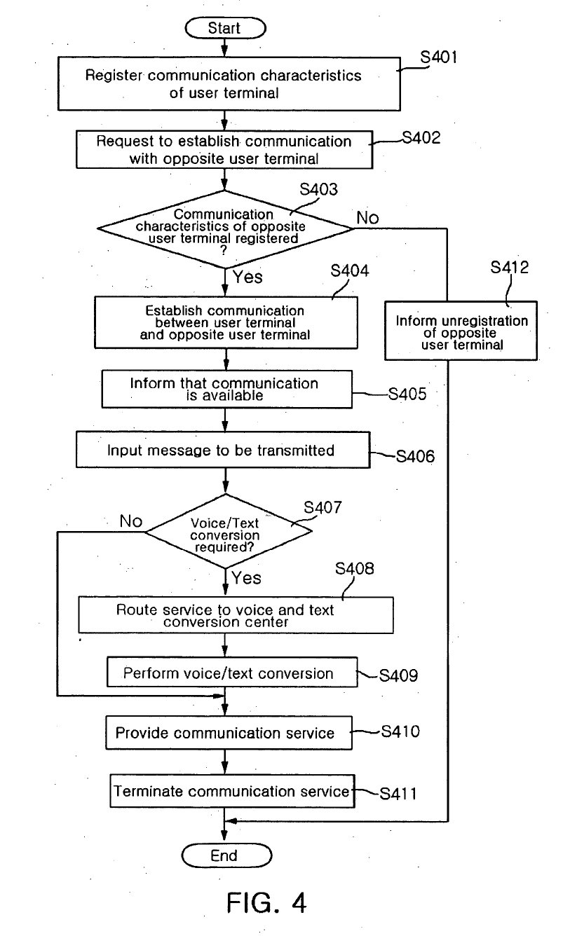

FIG. 4 is a flowchart of a method of providing an open API communication service for disabled persons according to an embodiment of the present invention. Referring to FIG. 4, a disabled person and a non-disabled person, first purchasing a communication terminal, register the characteristics of their communication terminals in the open API communication server 101 so as to be provided with the open API communication service for disabled persons at step S401. In this case, the characteristics of the communication terminals are the communication characteristics 150 to 162 supported according to the user terminals 105 to 108, as shown in FIG. 1. A user (transmitting user) desiring to use the communication service requests the open API communication server 101 to establish communication with a desired opposite user using his or her terminal at step S402. The open API communication server 101, having received the communication establishment request from the transmitting user, grasps the characteristics of the terminals of the transmitting user and the opposite user and then determines whether the communication characteristics of the opposite user terminal are registered at step S403. If the communication characteristics of the opposite user terminal are registered at step S403, the open API communication server 101 establishes the communication between the transmitting user terminal and the opposite user terminal at step S404. In this case, the open API communication server 101 establishes the communication by setting up and controlling a call in response to the communication service request from the user while supporting the network interface. In this way, if the establishment of the communication between the terminals has been completed, the open API communication server 101 informs the transmitting user terminal that the communication is available at step S405.

Thereafter, if a message to be transmitted to the opposite user terminal is input from the transmitting user terminal at step S406, the open API communication server 101 determines whether voice and text conversion is required with respect to the message in consideration of the communication characteristics of the transmitting user terminal and the opposite user terminal, thus selecting a service providing method at step S407. If the communication characteristics of the transmitting user terminal and the opposite (receiving) user terminal are different at step S407, the voice and text conversion is required for communication there between. If the communication characteristics of the transmitting user terminal and the receiving user terminal are different, for example, if the transmitting user is a speech disabled person and the receiving user is a visually disabled person, the speech disabled person can use the communication service by recognizing the thoughts or feelings of the opposite user through a voice data packet and expressing his or her thoughts or feelings in a writing manner. On the other hand, the visually disabled person can recognize the thoughts or feelings of the opposite user and express his or her thoughts or feelings through a voice data packet. At this time, text used to express the thoughts or feelings of the speech disabled person must be transmitted to the visually disabled person in the format of a voice data packet. Therefore, the open API communication server 101 for disabled persons utilizes the service routing function 205 to perform the voice and text conversion, thus routing the message input from the transmitting user to the voice and text conversion center 102 at step S408. The message received from the open API communication server 101 is converted into voice/text data depending on the communication characteristics of the opposite user terminal by the voice and text conversion center 102 at step S409. The voice and text conversion center 102 returns the voice/text data to the open API communication server 101, and the open API communication server 101 provides the communication service between the transmitting user terminal and the opposite user terminal at step S410. In this way, the transmitting user can safely and easily express his or her thoughts or feelings to the opposite user by utilizing the open API communication service for disabled persons. However, if the voice and text conversion is not required at step S407, a direct communication service between the transmitting user terminal and the opposite user terminal is possible, so that the communication service between the two terminals is directly performed at step S410. All communication services are terminated in response to termination requests from the transmitting and receiving users at step S411.

In the meantime, if it is determined that the communication characteristics of the opposite user terminal are not registered at step S403, the open API communication server 101 informs the transmitting user terminal that the communication characteristics of the opposite user terminal are not registered at step S412 and terminates the process.

The present invention uses the open API that provides a function of allowing existing and third party application services to safely and easily accesses the network and use network resources, independently from the characteristics of the network. Therefore, because a great number of application services utilize the network resources, a network service provider can create a new business model capable of providing benefits and application services according to the utilization of the network resources. Further, because existing and third party application service providers can easily utilize the network resources, they can create a service model extending over a variety of application services and network applications.

As described above, the present invention provides a communication service system and method based on an open API for disabled persons, which performs voice and text conversion in consideration of characteristics of respective user terminals, and allows users to safely and easily use communication services without inconvenience.

Further, the present invention is advantageous in that it allows disabled persons, estranged from communication services providing the convenience, to be provided with desired communication services through a more simple interface, and provides the method for communications between a disabled person and a non-disabled person, as well as communication between disabled persons, thus removing an obstacle to the communication means of the disabled persons, reducing the estrangement between non-disabled persons and disabled persons, and inspiring the confidence of the disabled persons for the participation in society.

Further, the present invention is advantageous in that it uses the open API that provides a function of allowing existing and third party application services to safely and easily accesses the network and use network resources, independently from the characteristics of the network. Therefore, because a great number of application services utilize the network resources, a network service provider can create a new business model capable of providing benefits and application services according to the utilization of the network resources. Further, because existing and third party application service providers can easily utilize the network resources, they can create a service model extending over a variety of application services and network applications.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A communication service system based on an open Application Programming Interface (API) for disabled persons, comprising:
a terminal unit implemented for a disabled person and a non-disabled person that access a wired/wireless integrated network and desire to be provided with communication services depending on communication characteristics registered with respect to the disabled person and the non-disabled person;
an open API gateway unit for providing an open API communication interface for the wired/wireless integrated network;
an open API unit for grasping communication characteristics of the terminal unit and accommodating a plurality of application functions for the communication services provided to the terminal unit;
an open API communication server unit for registering the communication characteristics of the terminal unit and providing voice and/or text communication services for the disabled person depending on the registered communication characteristics of the terminal unit; and
a voice and text conversion unit for converting data received from the open API communication server unit into voice and/or text having a format of requested service data depending on the characteristics of the disabled person, and returning the voice and/or text to the open API communication server unit.

2. The communication service system according to claim 1, wherein the terminal unit has user interfaces with communication characteristics for the communication services which can be used by a non-disabled person, an auditorily disabled person, a visually disabled person, and a speed disabled person, respectively.

3. The communication service system according to claim 2, wherein the non-disabled person has communication characteristics of hearing, speaking, reading and writing that are used as an interface, the visually disabled person has communication characteristics of hearing, speaking and writing that are used as an interface, the auditorily disabled person has communication characteristics of speaking, reading and writing that are used as an interface, and the speech disabled person has communication characteristics of hearing, reading and writing that are used as an interface.

4. The communication service system according to claim 1, wherein the open API gateway unit supports protocols, such as Session Initiation Protocol (SIP), Media Gateway Control (MAGACO) protocol, H. 323 protocol, Integrated Services Digital Network (ISDN) User Part (ISUP), Mobile Application Protocol (MAP), Intelligent Network Application Protocol (INAP), and Capabilities Application Protocol (CAP), which are used in the wired/wireless integrated network, and exploits middleware, such as Common Object Request Broker Architecture (CORBA) and Extensible Markup Language (XML) so as to communicate with the open API communication server.

5. The communication service system according to claim 1, wherein the open API unit comprises:
a framework unit for performing a plurality of functions including access to the communication services, registration, authentication and discovery of the communication services, integrity management, load management, and fault management; and
a service capability feature unit for providing a plurality of functions, including call control, messaging, user interaction, terminal capabilities, mobility, connectivity, presence and availability, and service routing, so as to allow application services to use resources and functions of the network.

6. The communication service system according to claim 1, wherein the open API communication server unit is operated so that, if a connection request is received from a specific user terminal to use a corresponding communication service, the server unit routes the communication service to the voice and text conversion unit when voice and/or text conversion is required in consideration of communication characteristics of transmitting and receiving user terminals, and provides a communication service corresponding to voice and/or text returned from the voice and text conversion unit.

7. The communication service system according to claim 1 or 6, wherein the open API communication server unit comprises:
a communication service unit for providing the communication service in consideration of communication characteristics between terminals of disabled persons and between terminals of a non-disabled person and a disabled person;
a registration unit for registering characteristics of the respective terminals when the terminals use the communication service first time;
a connection unit for supporting an interface with the wired/wireless integrated network and setting up a call in response to a communication service request received from the user;
a service routing unit for routing a corresponding communication service to support conversion into voice and/or text data in consideration of the characteristics of the respective terminals at the time of providing the communication service; and
an open API unit for providing API to allow a higher application to use the resources of the network.

8. A method of providing communication services based on an open Application Programming Interface (API) for disabled persons, comprising the steps of:
a) registering communication characteristics of terminals of a disabled person and a non-disabled person, desiring to be provided with a corresponding open API communication service in an open API communication server;
b) requesting the open API communication server to establish communication with a terminal of an opposite user desiring to use the communication service, using the registered terminal;
c) the open API communication server grasping communication characteristics of the terminals of the transmitting user and the opposite user, informing the transmitting user terminal that the communication service is available, and determining whether voice and/or text conversion for the communication service is required when a message is received from the transmitting user terminal;
d) converting the message into voice/text data depending on the communication characteristics of the opposite user terminal by a voice and text conversion center and providing the communication service using the voice/text, when the voice and/or text conversion is required; and
e) providing the communication service using the message when the voice and/or text conversion is not required.

9. The communication service method according to claim 8, wherein the communication characteristics of the terminals include hearing, speaking, reading and writing communication characteristics.

10. The communication service method according to claim 8, further comprising the step of setting up a call from the transmitting user terminal to the opposite user terminal in response to the communication establishment request at step b).

11. The communication service method according to claim 8, wherein the step d) comprises the steps of:
the open API communication server routing the message to the voice and text conversion center so as to perform voice/text conversion in consideration of the communication characteristics of the respective terminals;
the voice and text conversion center converting the message into voice and/or text depending on the communication characteristics of the opposite user terminal and returning the voice and/or text to the open API communication server; and
the open API communication server transmitting the voice and/or text returned from the voice and text conversion center to the opposite user terminal, thus providing the communication service.
